(19) United States
(12) Patent Application Publication
(10) Pub. No.: US 2011/0056834 A1
(43) Pub. Date: Mar. 10, 2011

(54) Dielectrophoresis-based microfluidic system

(76) Inventor: Shih-Kang Fan, Hsinchu (TW)

(21) Appl. No.: 12/591,693

(22) Filed: Nov. 30, 2009

(30) Foreign Application Priority Data
Sep. 4, 2009 (TW) 98129958

(51) Int. Cl. B03C 5/02

(52) U.S. Cl. 204/643

(57) ABSTRACT

A dielectrophoresis-based microfluidic system includes a first electrode plate, a second electrode plate and a spacing structure. The first electrode plate comprises a first substrate and an electrode layer disposed on one side surface of the first substrate. The second electrode plate comprises a second substrate and a plurality of electrodes. The electrodes are disposed on one side surface of the second substrate which is opposite to the electrode layer, and arranged in a microchannel pattern. The spacing structure is disposed between the first electrode plate and the second electrode plate so that a space is defined between the first electrode plate and the second electrode plate. Accordingly, users can inject microfluid into the space and apply voltage to different electrodes to drive the microfluid to flow towards different directions.

### BACKGROUND OF THE INVENTION

1. Field of the Invention

The present invention relates to a microfluidic system, and more particularly to a dielectrophoresis-based microfluidic system.

2. Description of Related Art

At present, microfluidic systems, or called microfluidic chips, are developed widely. Since microfluidic systems have the advantages of rapid reaction rate, high sensitivity, high reproducibility, low costs, low pollution, and so on, they are widely used in various applications such as biological application, medical application, and photoelectric application and so on.

A basic structure of a conventional microfluidic system includes a substrate in which one channel or a plurality of channels in micrometer size, or called microchannels, are formed. Fluid may fill in the microchannels and then flow in the microchannels.

Additionally, some microfluidic systems further include pumps for providing power for fluid so that the fluid can flow in microchannels successfully.

However, the above-mentioned microfluidic systems have the shortcoming of fixed microfluidic networks. Once a microfluidic system is manufactured, its microfluidic network is fixed and cannot be changed to make fluid flow in different directions. Furthermore, the placement of the pumps increases the overall dimensions of the microfluidic systems, thereby reducing the transportability.

Hence, the inventors of the present invention believe that the shortcomings described above are able to be improved and finally suggest the present invention which is of a reasonable design and is an effective improvement based on deep research and thought.

### SUMMARY OF THE INVENTION

A main objective of the present invention is to provide a dielectrophoresis-based microfluidic system which has unfixed virtual channels.

To achieve the above-mentioned objective, a dielectrophoresis-based microfluidic system in accordance with the present invention is provided. The dielectrophoresis-based microfluidic system includes: a first electrode plate which has a first substrate and an electrode layer disposed on one side surface of the first substrate; a second electrode plate which has a second substrate and a plurality of electrodes, wherein the electrodes are disposed on one side surface of the second substrate which is opposite to the electrode layer, and arranged in a microchannel pattern; and a spacing structure which is disposed between the first electrode plate and the second electrode plate so that a space is formed between the first electrode plate and the second electrode plate.

The dielectrophoresis-based microfluidic system of the present invention has the efficacy as following: the channels of the microfluidic system are virtual channels formed by the plurality of electrodes, thereby avoiding that conventional real channels limit flow directions of pumped fluid. As long as users apply voltage to different electrodes, the pumped fluid can flow to different locations, thereby achieving the intended result of programmable fluid manipulation. Additionally, since the present invention does not require a pump, the overall dimension of the present invention is smaller.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a perspective view of a first embodiment of a dielectrophoresis-based microfluidic system of the present invention;

FIG. 2 is a planar cross-sectional view of the first embodiment of the dielectrophoresis-based microfluidic system of the present invention;

FIG. 3 is a schematic view of a microchannel pattern of the first embodiment of the dielectrophoresis-based microfluidic system of the present invention;

FIG. 4 is a schematic view of the first embodiment of the dielectrophoresis-based microfluidic system of the present invention, connected with a driving circuit board and a controller;

FIG. 5 is a schematic view of the first embodiment of the dielectrophoresis-based microfluidic system of the present invention, in a used state;

FIG. 6 is a first schematic view of the first embodiment of the dielectrophoresis-based microfluidic system of the present invention separating DNA sample liquid;

FIG. 7 is a second schematic view of the first embodiment of the dielectrophoresis-based microfluidic system of the present invention separating DNA sample liquid;

FIG. 8 is a perspective view of a second embodiment of the dielectrophoresis-based microfluidic system of the present invention;

FIG. 9 is a perspective view of a third embodiment of the dielectrophoresis-based microfluidic system of the present invention;

FIG. 10 is a perspective view of a fourth embodiment of the dielectrophoresis-based microfluidic system of the present invention;

FIG. 11 is a schematic view of a microchannel pattern of a fifth embodiment of the dielectrophoresis-based microfluidic system of the present invention; and

FIG. 12 is a perspective view of a sixth embodiment of the dielectrophoresis-based microfluidic system of the present invention.

### DETAILED DESCRIPTION OF THE PREFERRED EMBODIMENTS

The present invention provides a dielectrophoresis-based microfluidic system with unfixed virtual channels for users to manipulate microfluids programmably. The dielectrophoresis-based microfluidic system can be referred as “microfluidic system” for short below.

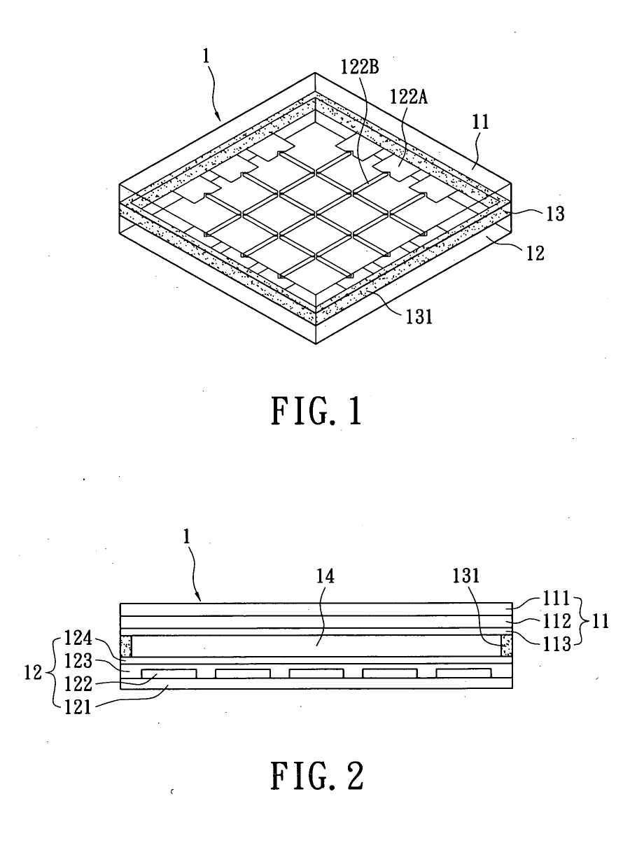

Please refer to FIG. 1 and FIG. 2 illustrating a first preferred embodiment of the dielectrophoresis-based microfluidic system 1 according to the present invention, which includes a first electrode plate 11, a second electrode plate 12 and a spacing structure 13.

The following is to demonstrate the features of each of components and then the connection relationship between the components. Each direction (up, down, front, rear, left or right) in the following description is only used to express a relative direction, and doesn't limit the actual used directions of the dielectrophoresis-based microfluidic system 1.

The first electrode plate 11 includes a first substrate 111, an electrode layer 112 and a first hydrophobic layer 113. The first substrate 111 is a rectangular plate of which a material may be glass, silicon substrate, poly-dimethylsiloxane (PDMS), polyethylene terephthalate (PET), polyethylene naphthalate (PEN) or a flexible polymer material etc.

The electrode layer 112 is disposed on the bottom surface of the first substrate 111 and covers the whole bottom surface of the first substrate 111. The material of the electrode layer 112 may be a conductive metal material, a conductive polymer material or a conductive oxide material etc., such as Cr/Cu metal or indium tin oxide (ITO) etc.

The electrode layer 112 is deposited on the first substrate 111 via E-beam evaporation, physical vapor deposition, sputtering etc.

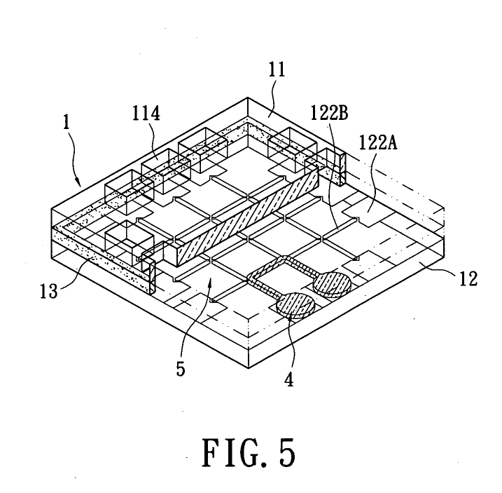

The first hydrophobic layer 113 is disposed on the bottom surface of the electrode layer 112 and covers the whole bottom surface of the electrode layer 112. The material of the first hydrophobic layer 113 may be a hydrophobic material such as Teflon and so on. The effect is that the pumped fluid 4 mentioned below (please refer to FIG. 5) has a hydrophobic characteristic, or the surface of the first electrode plate 11 is hydrophobic to the pumped fluid 4, which is convenient for driving the pumped fluid 4. The first hydrophobic layer 113 is deposited on the electrode layer 112 via physical or/and chemical deposition or spin coating etc.

Even if the first hydrophobic layer 113 is not disposed on the electrode layer 112, it will not cause that the pumped fluid 4 cannot be driven. Furthermore, if the pumped fluid 4 has a good hydrophobic characteristic itself, or its surface energy is large, then it is not required to dispose the first hydrophobic layer 113 on the electrode layer 112. In other words, for the first electrode plate 11, the first hydrophobic layer 113 is optional.

The above is the illustration for the first electrode plate 11, and the following is to describe the second electrode plate 12.

The second electrode plate 12 includes a second substrate 121, a plurality of electrodes 122, a dielectric layer 123 and a second hydrophobic layer 124.

The second substrate 121 is similar to the first substrate 111, that is, the second substrate 121 is a rectangular plate and the material of the second substrate 121 may be glass, silicon substrate, poly-dimethylsiloxane (PDMS), polyethylene terephthalate (PET), polyethylene naphthalate (PEN) or a flexible polymer material etc.

The electrodes 122 are disposed on the top surface of the second substrate 121. The material of the electrodes 122 is similar to that of the conductive layer 121 and may be a conductive metal material, a conductive polymer material or a conductive oxide material etc., such as Cr/Cu metal or Indium tin oxide (ITO) etc. The shape and the arrangement of the electrodes 122 depend on a particular microchannel pattern.

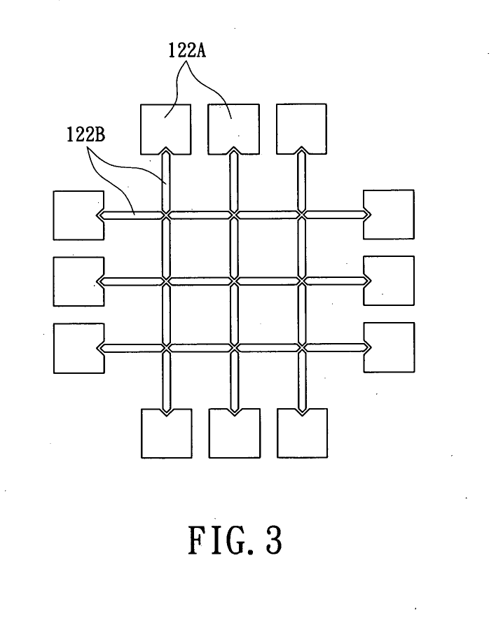

Please further refer to FIG. 3, the microchannel pattern includes a plurality of quadrate reservoirs 122A and a plurality of long-strip-shaped channels 122B. Each of the reservoirs 122A and the channels 122B is one of the electrodes 122. Each channel 122B is connected with other three channels 122B (there are spaces between the channels) to form a cruciform channel, and each reservoir 122A is connected with several channels 122B located on more peripheral positions. The functions of the reservoirs 122A and the channels 122B will be explained in the following operating instructions of the microfluidic system 1.

The manufacturing process for the electrodes 122 is as following: depositing a layer of material on the second substrate 112 via E-beam evaporation, physical vapor deposition, or sputtering etc. and removing unwanted materials via etching and so on to form the plurality of electrodes 122 arranged in the microchannel pattern. The electrodes 122 may also be manufactured via other processes, such as lift-off and so on.

The dielectric layer 123 is disposed on the electrodes 122 and covers all of the electrodes 122. The material of the dielectric layer 123 may be various dielectric materials, such as parylene, positive photoresist, negative photoresist, materials with high dielectric constant, or materials with low dielectric constant.

The second hydrophobic layer 124 is disposed on the top surface of the dielectric layer 123 and covers the whole dielectric layer 123. The material of the second hydrophobic layer 124 is similar to that of the first hydrophobic layer 113 and may be a hydrophobic material such as Teflon and so on. The effect is that the pumped fluid 4 (please refer to FIG. 5) has a hydrophobic characteristic, or the second electrode plate 12 is hydrophobic to the pumped fluid 4, which is convenient for driving the pumped fluid 4.

The dielectric layer 123 is formed by depositing the material of the dielectric layer 123 on the second substrate 121 and the electrodes 122, and the second hydrophobic layer 124 may also be formed by depositing the material of the second hydrophobic layer 124 on the dielectric layer 123.

Additionally, for the second electrode plate 12, the dielectric layer 123 is optional. That is, as long as the dielectric characteristic of the pumped fluid 4 meets the applied requirements, it doesn't need the dielectric layer 123 existing in the second electrode plate 12. For the second electrode plate 12, the second hydrophobic layer 124 is optional. As long as the pumped fluid 4 has the hydrophobic characteristic itself, or the surface of the electrode plate 12 is hydrophobic to the pumped fluid 4, it does not need to dispose the second hydrophobic layer 124 on the dielectric layer 123.

The above is the illustration of the second electrode plate 12, and the following is the illustration for the spacing structure 13. The spacing structure 13 includes four spacers 131, each of which may be an insulating spacer. The four spacers 131 are arranged in a continuous frame structure.

The above is the explanation of each of components of the microfluidic system 1, and then the connection relationship between the components is to be explained. The first electrode plate 11 and the second electrode plate 12 are arranged in parallel. The electrode layer 112 is opposite to the electrodes 122. The spacers 131 of the spacing structure 13 are disposed between the first electrode plate 11 and the second electrode plate 12, so that a space 14 is defined between the first electrode plate 11 and the second electrode plate 12.

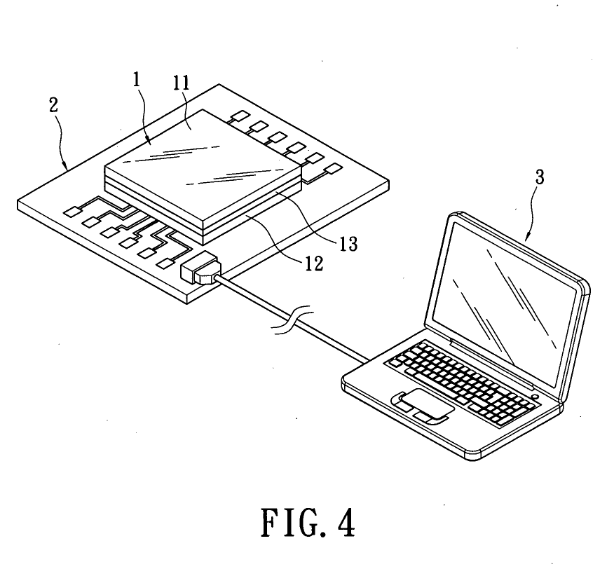

Please refer to FIG. 4, the microfluidic system 1 is further mounted on a driving circuit board 2 and electrically connected with the driving circuit board 2 by wires or connectors, so that the driving circuit board 2 provides voltage to the electrode layer 112 and the electrodes 122 of the microfluidic system 1.

A controller 3 (for example, a desktop computer, a notebook computer, a personal digital assistant or a mobile phone etc.) is connected with the driving circuit board 2 with or without wires. Users can set various control programs in the controller 3, so that the controller 3 can send a control signal to the driving circuit board 2 according to the control programs and the driving circuit board 2 can supply voltage for different electrodes 122 according to the control signal.

Please refer to FIG. 5, during using the microfluidic system 1, at first, injecting one kind of pumped fluid 4 into the microfluidic system 1, that is, placing the pumped fluid 4 in the space 14 on one or a plurality of electrodes 122 (reservoirs 122A). Then, injecting one kind of surrounding fluid 5 into the space 14 to surround the pumped fluid 4. The pumped fluid 4 and the surrounding fluid 5 is injected into the space 14 through an opening 114 of the first electrode plate 11, and the opening 114 is located over the reservoirs 122A.

It is noted that the dielectric constant of the pumped fluid 4 must be greater than that of the surrounding fluid 5 so that the pumped fluid 4 can flow basing on the dielectrophoresis phenomenon. So the pumped fluid 4 may be water and the surrounding fluid 5 may be air or silicone oil; or alternatively, the pumped fluid 4 may be silicone oil and the surrounding fluid 5 may be air. The above-mentioned pumped fluid 4 and surrounding fluid 5 are only examples and are not merely limited thereto.

After the pumped fluid 4 and the surrounding fluid 5 is injected into the microfluidic system 1, the driving circuit board 2 applies voltage to the electrode layer 112 and one of the electrodes 122, so that the electric field between the electrode layer 112 and the electrodes 122 changes. The pumped fluid 4 and the surrounding fluid 5 is polarized in varying degrees, so that the pressure difference exists between the pumped fluid 4 and the surrounding fluid 5, and then the pumped fluid 4 flows in the low-pressure direction. The phenomenon is called a dielectrophoresis phenomenon and the pressure difference between the pumped fluid 4 and the surrounding fluid 5 may be called a dielectrophoresis force.

Accordingly, as long as the driving circuit board 2 applies voltage to different electrodes 122, the pumped fluid 4 will flow towards the electrode 122 to which the voltage is applied; that is, without a pump, the pumped fluid 4 can be controlled to flow towards different directions.

In other words, the configuration of the channels of the microfluidic system 1 is unfixed and changeable with applying voltages to different electrodes 122. Users write control programs to control the driving circuit board 2 to apply voltage to different electrodes 122, thereby controlling the pumped fluid 4 to flow towards different electrodes 122. Accordingly, the programmable microfluid control can be achieved.

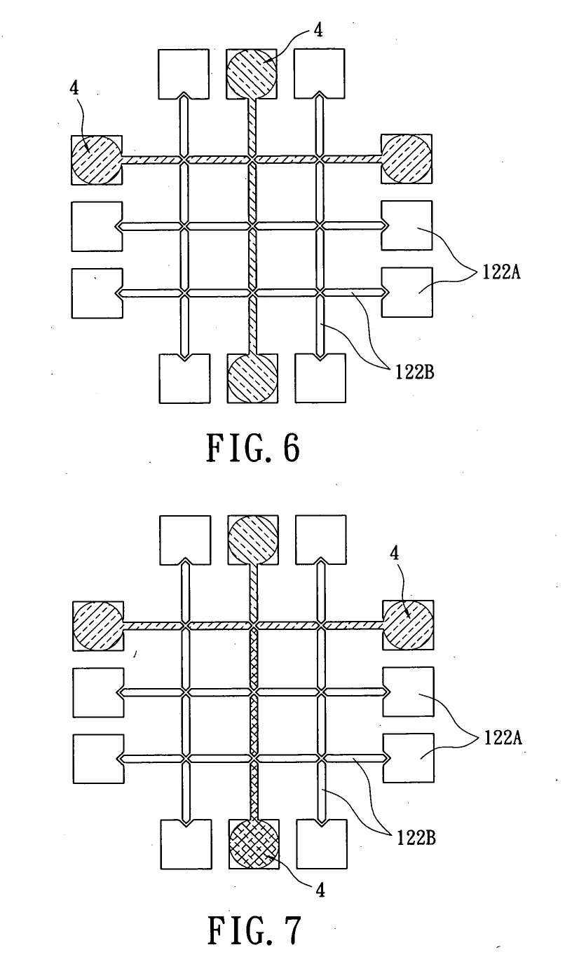

Please refer to FIG. 6, the above-mentioned microfluidic system 1 may be used to separate DNA. Inject DNA sample liquid (the pumped fluid) 4 into the left uppermost and the right uppermost reservoirs 122A, and then inject buffer liquid (the pumped fluid) 4 into the upper middle and the lower middle reservoirs 122A.

Subsequently, applying voltages to four longitudinal channels 1228 between the upper middle reservoir 122A and the lower middle reservoir 122A, so that the buffer liquid 4 flows into the four longitudinal channels 122B. That is, the four longitudinal channels 122B are filled with the buffer liquid 4. Further, applying voltages to four transversal channels 122B between the left uppermost reservoir 122A and the right uppermost reservoir 122A, so that the DNA sample liquid 4 flows into the four transversal channels 122B. That is, the four transversal channels 122B are filled with the DNA sample liquid 4. The DNA sample liquid 4 and the buffer liquid 4 flows crosswise.

Please refer to FIG. 7, finally, applying voltages to four longitudinal channels 122B between the upper middle reservoir 122A and the lower middle reservoir 122A, so that the crossed DNA sample liquid 4 flows towards the lower middle reservoir 122A basing on the electrophoresis force and electroosmosis, and separates in the channels 122B basing on the mass-to-charge ratio.

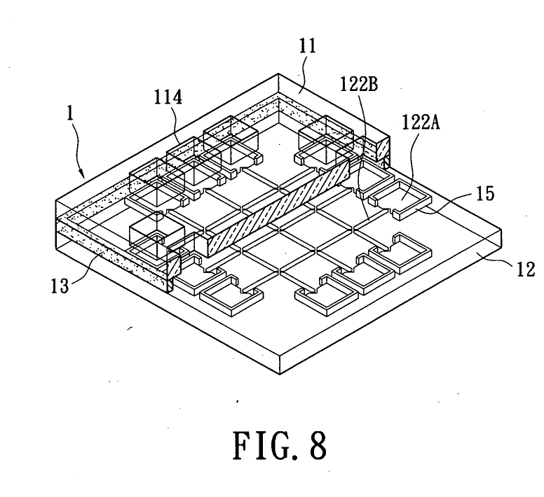

The above is the first embodiment of the microfluidic system 1 of the present invention. Please refer to FIG. 8 illustrating a second embodiment of the microfluidic system 1 of the present invention. The difference between the second embodiment and the first embodiment is that the microfluidic system 1 of the second embodiment further includes a plurality of fence structures 15 disposed on the top surface of the second electrode plate 12 and respectively surrounding each reservoir 122A.

When the pumped fluid 4 is injected into the reservoirs 122A, the fence structures 15 can help the pumped fluid 4 keep in the reservoirs 122A and ensure that the amount of the pumped fluid 4 in each reservoir 122A is equal.

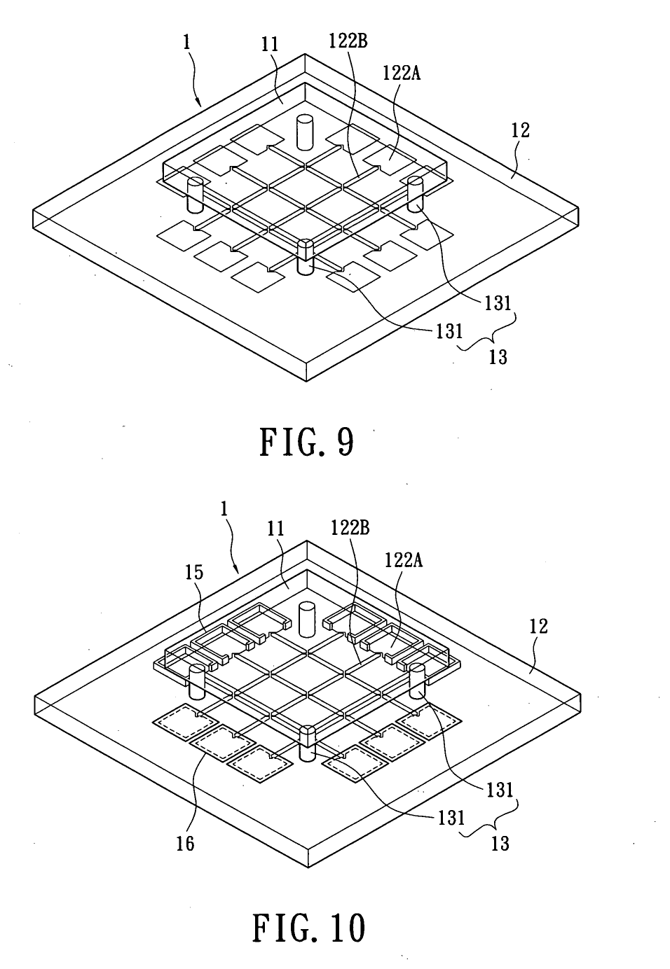

Please refer to FIG. 9, illustrating a third embodiment of the microfluidic system 1 of the present invention. The difference between the third embodiment and the first embodiment is that the area of the first electrode plate 11 of the microfluidic system 1 of the third embodiment is larger than that of the second electrode plate 12, the spacing structure 13 includes four individual spacers 131 respectively located at four corners of the first electrode plate 11 and the second electrode plate 12, and the reservoirs 122A are located on the periphery of the first electrode plate 11.

During using the microfluidic system 1, the pumped fluid 4 is dripped in the reservoirs 122A of the second electrode plate 12, and voltage is applied to different electrodes 122 so that the pumped fluid 4 flows between the first electrode plate 11 and the second electrode plate 12 under the effect of dielectrophoresis.

Please refer to FIG. 10, illustrating a fourth embodiment of the microfluidic system 1 of the present invention. The difference between the fourth embodiment and the third embodiment is that the microfluidic system 1 of the fourth embodiment further includes a plurality of fence structures 15 and a plurality of hydrophilic layers 16 which are respectively prepared on the top surface of the first electrode plate 11 and located over the partial reservoirs 122A.

During using the microfluidic system 1, the pumped fluid 4 is dropped in the fence structures 15 or on the hydrophilic layers 16. The pumped fluid 4 is kept in the fence structures 15 or on the hydrophilic surface 16, and doesn't flow between the first electrode plate 11 and the second electrode plate 12 until the electrodes 122 are electrified.

Furthermore, the fence structures 15 and the hydrophilic layers 16 can be applied in the third embodiment of the microfluidic system 1, independently, and are not limited in any specific combinations by applying them. In the microfluidic system 1 of the second embodiment, all or partial of the fence structures 15 may be replaced by the hydrophilic layers 16 In other words, the microfluidic system 1 may selectively have one kind of or all kinds of the opening 114, the fence structures 15 and the hydrophilic layers 16.

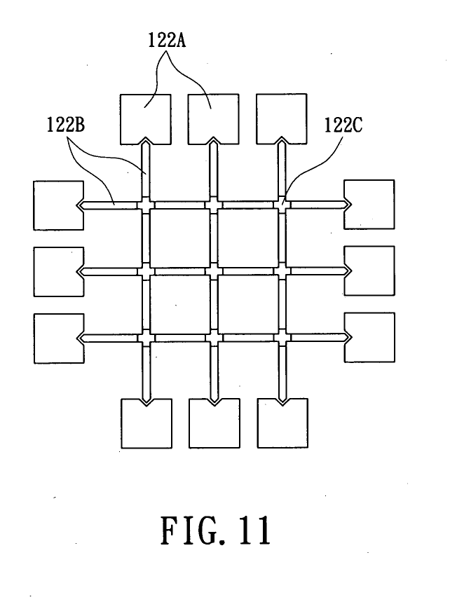

Please refer to FIG. 11, illustrating a fifth embodiment of the microfluidic system 1 of the present invention. The difference between the fifth embodiment and the above-mentioned embodiments is that the microfluidic pattern formed by the electrodes 122 further includes a plurality of joints 122C of which each is connected with at least two channels 122B. The joints 122C may also be applied voltage to so as to help the pumped fluid 4 change its flow direction.

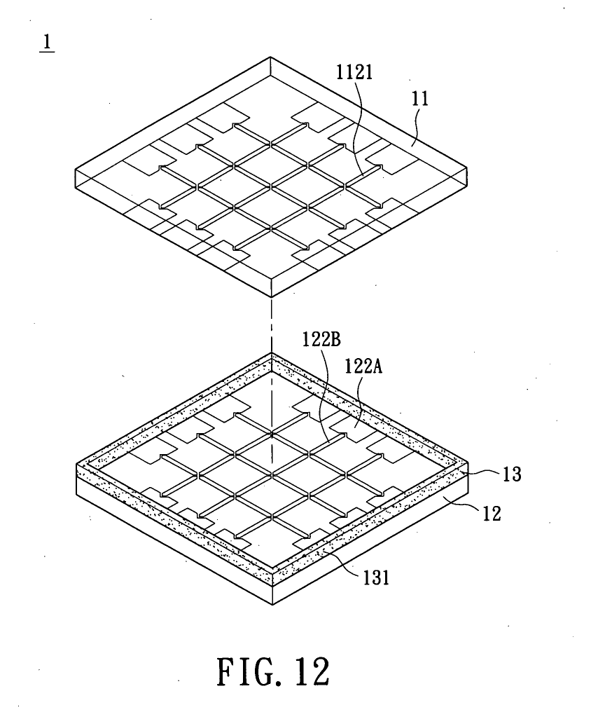

Please refer to FIG. 12, illustrating a sixth embodiment of the microfluidic system 1 of the present invention. The difference between the sixth embodiment and the above-mentioned embodiments is that the electrode layer 112 of the first electrode plate 11 does not cover the whole bottom surface of the first substrate 111, and comprises a plurality of the electrodes 1121. The electrodes 1121 are arranged in another microchannel pattern, which may be the same to the microchannel pattern of the electrodes 122.

Using the microfluidic system 1 of the sixth embodiment is similar to using the microfluidic system 1 of other embodiments. Voltage is applied to the designated electrode 122 and the corresponding electrode 1121, and then the pump fluid 4 will flow towards the designated electrodes.

Consequently, the dielectrophoresis-based microfluidic system of the present invention has the characteristics as follows: the channels of the microfluidic system are virtual channels formed by a plurality of electrodes, thereby avoiding that conventional real channels limit the flow directions of the pumped fluid. As long as users apply voltages to different electrodes, the pumped fluid can flow in different directions, thereby achieving the intended result of the programmable fluid manipulation. Additionally, since the present invention does not require a pump, the present invention has smaller size and can be manufactured in a semiconductor fabrication process.

What are disclosed above are only the specifications and the drawings of the preferred embodiments of the present invention and it is therefore not intended that the present invention be limited to the particular embodiments disclosed. It will be understood by those skilled in the art that various equivalent changes may be made depending on the specifications and the drawings of the present invention without departing from the scope of the present invention.

What is claimed is:

1. A dielectrophoresis-based microfluidic system, comprising:
a first electrode plate, comprising a first substrate and an electrode layer disposed on one side surface of the first substrate;
a second electrode plate, comprising a second substrate and a plurality of electrodes, the electrodes disposed on one side surface of the second substrate which is opposite to the electrode layer, and arranged in a microchannel pattern; and
a spacing structure, disposed between the first electrode plate and the second electrode plate so that a space is defined between the first electrode plate and the second electrode plate.

2. The dielectrophoresis-based microfluidic system as claimed in claim 1, wherein the microchannel pattern includes a plurality of reservoirs and a plurality of channels, in which the reservoirs are respectively connected with one or more than one of the plurality of channels, and each of the channels is in fluid communication with at least one another of the plurality of channels.

3. The dielectrophoresis-based microfluidic system as claimed in claim 2, wherein the microchannel pattern further includes a plurality of joints of which each is connected with at least two channels of the plurality of channels.

4. The dielectrophoresis-based microfluidic system as claimed in claim 1, wherein the spacing structure has a plurality of spacers.

5. The dielectrophoresis-based microfluidic system as claimed in claim 1, wherein the first electrode plate further has a hydrophobic layer disposed on the electrode layer.

6. The dielectrophoresis-based microfluidic system as claimed in claim 1, wherein the second electrode plate further has a dielectric layer disposed on the electrodes.

7. The dielectrophoresis-based microfluidic system as claimed in claim 6, wherein the second electrode plate further has a hydrophobic layer disposed on the dielectric layer.

8. The dielectrophoresis-based microfluidic system as claimed in claim 1, wherein the first electrode plate further has a plurality of openings.

9. The dielectrophoresis-based microfluidic system as claimed in claim 1, further comprising a plurality of fence structures disposed on a top surface of the second electrode plate.

10. The dielectrophoresis-based microfluidic system as claimed in claim 1, further comprising a plurality of hydrophilic layers prepared on a top surface of the second electrode plate.

11. The dielectrophoresis-based microfluidic system as claimed in claim 1, further comprising a pumped fluid located in the space over one or more than one electrodes of the plurality of electrodes.

12. The dielectrophoresis-based microfluidic system as claimed in claim 11, further comprising a surrounding fluid located in the space and surrounding the pumped fluid.

13. The dielectrophoresis-based microfluidic system as claimed in (claim 12, wherein dielectric constant of the pumped fluid is greater than that of the surrounding fluid.

14. The dielectrophoresis-based microfluidic system as claimed in claim 1, wherein the first electrode layer comprises a plurality of electrodes arranged in another microchannel pattern.
